(19) United States
(12) Patent Application Publication
(10) Pub. No.: US 2008/0259157 A1
(43) Pub. Date: Oct. 23, 2008

(54) Lenticular Design By Applying Light Blocking Feature

(75) Inventor: Age Jochem Van Dalfsen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/089,215

(22) PCT Filed: Oct. 3, 2006
(86) PCT No.: PCT/IB2006/053601

§ 371 Date: Apr. 4, 2008

(30) Foreign Application Priority Data
Oct. 4, 2005 (EP) 05109202.1

(51) Int. Cl. H04N 13/04

(52) U.S. Cl. 348/59; 348/E13.01

(57) ABSTRACT

An autostereoscopic display apparatus (104, 200, 301, 401, 501) is disclosed, comprising lenticular means (203, 305, 402, 502) configured to direct and control light emitted from a source (201, 302). The lenticular means comprises an array of lenticular elements (204, 306, 403, 503), said array of lenticular elements comprising a first surface facing light incident from said source and a second surface facing light emergent from said second surface. The apparatus further comprises a light-absorbing repetitive pattern (507, 517) restricting light passing through said lenticular elements to only a desired portion of said lenticular elements, said light-absorbing repetitive pattern being applied on said second surface of said lenticular means. Use of the autostereoscopic display apparatus in a 3D display and/or multi-view static or dynamic display is also disclosed.

The present invention relates to an autostereoscopic display apparatus comprising lenticular means configured to direct and control light emitted from a source. In particular, the present invention relates to applying a light-absorbing repetitive pattern restricting light passing through said lenticular elements to only a desired portion of said lenticular elements. The present invention further relates to use of such a display apparatus in a 3D display and/or multi-view static or dynamic display.

Three dimensional imaging is a well-known technique today. However, traditionally it has been in the form of stereoscopic images where the user has had to have optical manipulating devices of a kind, especially glasses providing separated light transmission in order to obtain the three dimensional effect.

A more recent development is the ability to construct displays with inherent 3D capabilities with no need for extra equipment for the user to carry. One such a technology is autostereoscopy.

One example of autostereoscopy is based on directing light emanating from a two-dimensional display array of pixels in different directions. The different directions of the light results in a slight angular disparity, which, by the slightly separated eyes of a human, makes the image being perceived as having three dimensions. One technique to separate light coming from different regions is the use of parallax barriers. A parallax barrier causes the light direction separation by means of alternating transmissive and opaque regions such as slits or light lines interspersed by dark regions. Another example of a light separation technique is the use of lenses in front of a display device. The light emanating from a subpixel is concentrated in certain directions by means of a lense, or lenticular, thus avoiding the light loss associated with the barrier-based device.

Depending on the configuration of the lenticular the subpixels of a display are subdivided into a predetermined number of distinct subsets, or views. Also dependent on the configuration of the lenticular is how well separated these views are, or, in other words how many of the neighbouring views that are visible for an observer in one viewing position. For instance, in a configuration with a lenticular comprising of cylindrical lenticules having a slant angle of atan(⅙) with respect to the vertical direction, and a horizontal pitch of 1.5 display pixels, three views are visible in the theoretical, idealised case. The effect of partial overlapping of images, generally referred to as “crosstalk”, is a desirable property of such a system, since any system having absolutely no crosstalk would have each single view switch abruptly at certain eye positions, resulting in a jumping picture in case of lateral eye movement.

One way of reducing scattered light is by blocking light coming from one part of a display, e.g. using black striping to improve daylight contrast of CRT and matrix displays, or in the lenticular of a rear-view projection TV.

U.S. Pat. No. 5,359,454 discloses a display apparatus comprising two optical layers, an outer and an inner. The outer layer comprises light focusing optics and the inner layer comprises light control optics. The light control optics comprise a pattern of bright zones disposed parallel to the axial direction of the outer layer. The bright zones are separated by light absorbing, or light dispersing, dark zones. In this way, a light directional control function is achieved restricting light emitted from selected regions of the light emitting source. However, crosstalk emanating from these regions of a display are not the only source to crosstalk.

Due to various reasons, the amount of crosstalk is in practice greater, or even much greater, than that in the ideal case. Furthermore, there are no viewing positions where a certain view has zero visibility. The result is reduced image quality with reduced sharpness, especially in 3D imaging. Furthermore, it is also a problem in the purpose of presenting totally different pictures in two distinct angles, such as in the case where two persons are sitting on a couch, each watching a different program.

In order to take the proper measures in order to overcome the problem with crosstalk it is essential to have the insight as to what causes the extra amount of crosstalk.

It is thus an object of the present invention to overcome the drawbacks of prior art solutions and, in particular, to overcome the cause for the extra crosstalk. Furthermore, it is also an object of the present invention to reduce the viewing angle dependence of the crosstalk. Furthermore, it is also an object of the present invention to provide an improved lenticular screen which is easy to manufacture.

The invention is based on the insight that light passing the lenticules in the close neighbourhood of the lenticule edges, can come from the “wrong places”, due to non-ideal manufacturing of the lenticular. In an ideal lenticular the lenticules meet at a razor sharp edge, so that the light rays passing on either side of and close to the joining line of two lenticules, come from two clearly distinct regions of the emitting display. If however the meeting edge is not sharp, as can occur due to various manufacturing reasons, all the intermediate points between the two regions will be reached by some of the rays.

According to the present invention there is provided an autostereoscopic display apparatus comprising lenticular means configured to direct and control light emitted from a source, said lenticular means comprising an array of lenticular elements, said array of lenticular elements comprising a first surface facing light from said source incident to said first surface and a second surface facing light emergent from said second surface, said apparatus further comprising a light-absorbing repetitive pattern restricting light passing through said lenticular elements to only a desired portion of said lenticular elements, said light-absorbing repetitive pattern being applied on said second surface of said lenticular means.

Hence, by blocking the light that would otherwise cross the “bad” positions on the lenticules, these false rays do not increase crosstalk between views but are intercepted.

The non-ideality of the form of the lenticular grooves can also be of a more random light scattering kind, also amounting to light rays coming from wrong places.

A second benefit of applying this light-absorbing repetitive pattern is that the crosstalk caused by “normal” lens aberrations, such as spherical aberration, is also reduced. In this way the light-absorbing repetitive pattern acts as an aperture stop and, hence, reduces view crosstalk in an efficient way.

Furthermore, by applying the light absorbent material in direct connection with the lenticular, improved alignment can be achieved between the lenticular and the light-absorbing repetitive pattern. Hence, this property is particularly desired in the manufacturing process.

According to a second embodiment of the invention, the portion of the lenticular elements comprises a central portion, or sector, of a lenticular element. The wording “central” is in this context to be construed as being in a direction away from the grooves created where the individual lenticular elements meet.

Hence, the size and position of the coating can be optimised to get the best compromise between improved crosstalk behaviour and remaining screen brightness.

According to a third embodiment of the invention, the light-absorbing repetitive pattern comprises essentially black striping applied directly onto the lenticular elements. Advantageously the black striping is applied in grooves between the lenticular elements. In this way, not only the optical performance, or view crosstalk, of the lenticular will is improved, but also a high degree of precision is obtained. Furthermore, the brightness is only reduced as much as the corresponding amount of the fill factor of the black stripes and, thereby, the reduction of brightness is minimized.

According to a fourth embodiment of the invention, the light-absorbing repetitive pattern is applied by means of screen-printing and/or inkjet printing. Hereby, efficient and precise manufacture is obtained.

According to a fifth embodiment of the invention, the light-absorbing repetitive pattern comprises an electrically switchable pattern. Hereby, the light-absorbing effect can be controlled.

A further object of the present invention is to improve the optical characteristics of an autostereoscopic display apparatus by avoiding direct optical contact between lenticular elements and a glass plate placed in front of the lenticular elements.

The object is achieved with an autostereoscopic display apparatus as described in any of the preceding embodiments wherein the light-absorbing repetitive pattern further provides spacing between the lenticular elements and a glass plate in front of the second surface.

The spacing will improve the optical characteristics of the system by avoiding direct optical contact between the lenticules and the glass plate. Optical imperfections, such as the emergence of Newton fringes and degradation in effectiveness with anti-reflex coatings will be reduced.

It is a further object of the invention to provide a use of an autostereoscopic display apparatus as described in any previous embodiments in a 3D display and/or multi-view static or dynamic display.

Embodiments of the present invention will now be described, by way of examples only, with reference to the accompanying drawings, in which:

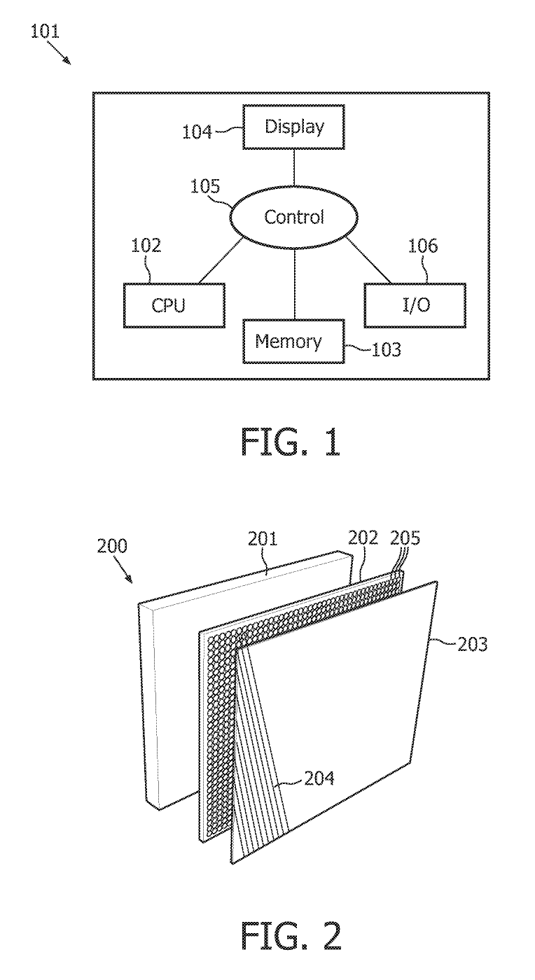

FIG. 1 shows schematically a block diagram of an autostereoscopic display apparatus according to the present invention;

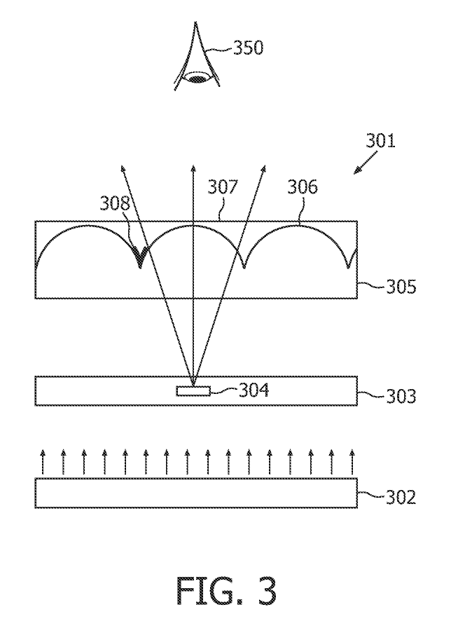

FIG. 2 shows schematically a perspective view of one embodiment of the layers of a display device according to the invention;

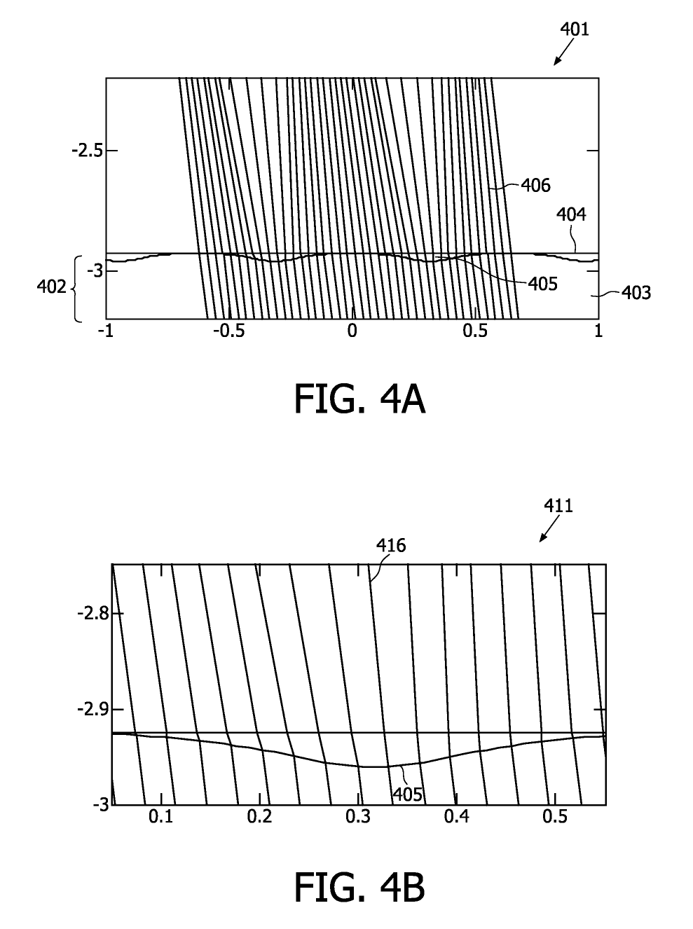

FIG. 3 shows schematically a cross-sectional view of a lenticular screen structure;

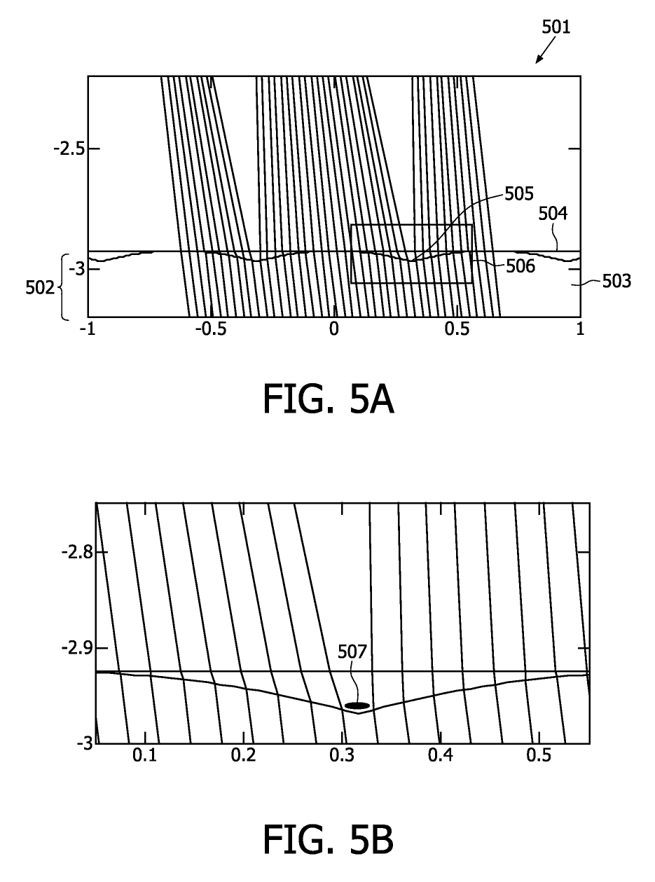

FIG. 4 shows schematically a cross-sectional view of a lenticular screen structure in section a) and a close-up in section b) according to an embodiment of the invention; and

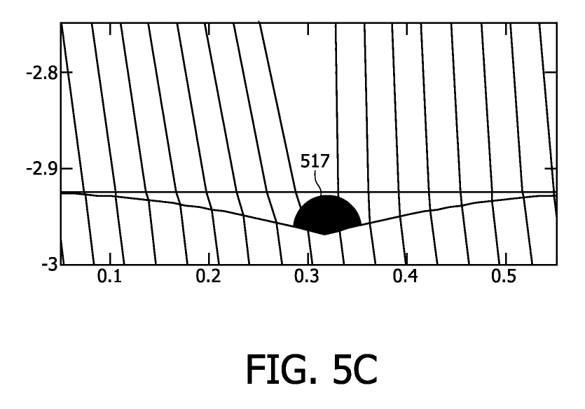

FIG. 5 shows schematically a cross-sectional view of the layers of a display device according to one embodiment of the invention in section a), with a close-up in section b), and a modified embodiment in section c).

FIG. 1 illustrates schematically an autostereoscopic display apparatus 101 in which the present invention is implemented. The apparatus 101 is capable of processing signals for the production of images. The apparatus 101 comprises a processor 102, memory 103, a display device 104, a control unit 105 as well as an input/output unit 106 for receiving information signals from an external unit (not shown) such as a computer. The general features regarding how these units communicate and operate are known to the person skilled in the art and is therefore not discussed further.

FIG. 2 is a schematic view of a display device 200 according to the invention. The display device 200 may be similar to the display device 104 in the apparatus 101 in FIG. 1. The display device 104 comprises a light source 201, a matrix LC display 202 and lenticular means 203. The lenticular means 203 comprise lenticular elements 204 for refracting light emanating from the LC display 202. The light source 201 illuminates the LC display 202 comprising pixels 205 arranged in a row and column matrix. The light from the light source 201 illuminates the LC display 202 and propagates through the lenticular elements. Preferably, the lenticular means comprises a lenticular screen.

One configuration of such a display device is a lenticular comprising of cylindrical lenses, or lenticules, having a slant angle of atan(⅙) with respect to the vertical direction, and a horizontal pitch of 1.5 display pixels (=4.5 sub pixels of the standard RGB type LCD display) resulting in a subdivision of the display subpixels into 9 distinct subsets, or views as observed by an observer.

FIG. 3 is a schematic view of a cross section of a small area of a display device 301 such as the display devices 104 and 200 described above. The display device 301 comprises a light source 302 and an LC display 303 comprising pixels 304. Lenticular means 305 are arranged in front of the display as viewed by a viewer 350, and comprises lenticular elements 306. Further in front of the lenticular elements is arranged a glass plate 307. The lenticular elements 306 may comprise an LC material (not shown) and the remainder of the space between the lenticular elements 306 and the glass plate 307 may be filled with a plastic material (not shown). In the figure, a coating 308 is applied directly onto the grooves of a convex lenticular (here shown with the convex side pointing towards an intermediate glass plate between the display glass and the lenticular). However, there may be other suitable alternatives of applying the coating which are known to the person skilled in the art.

FIG. 4 shows a schematic view of a cross section of a small area of a display device 401, 411 in section a), with a close-up in section b). In FIG. 4 it is shown a lenticular layer 402 comprising lenticular elements 403, a glass plate 404 and a groove 405. Ideally, manufactured lenticular elements should meet at virtually razor sharp angles, allowing light rays passing on either side of, and close to, the meeting edge. However, due to manufacturing reasons, lenticular elements practically have smoothened meeting edges through which light rays 406 and 416 passes.

FIG. 5 shows a schematic view of a cross section of a small area of a display device 501 according to the invention. It is shown a a lenticular layer 502 comprising lenticular elements 503, a glass plate 504 and a groove 505. FIG. 5, section a) shows how a light-absorbing repetitive pattern restricts light going in certain unwanted regions. FIG. 5, section b) shows a more detailed view 506 where a light-absorbing striping 507 is applied. FIG. 5, section c) shows a detailed view of a light-absorbing pattern 517 also providing spacing between the lenticular layer 502 and the glass plate 504.

The numbers indicated in FIGS. 4 and 5 are provided to give an idea of typical measurements. The unit is mm, the emitting surface is at ordinate z=0 mm and the viewing position is at z=−3000 mm, x=500 mm.

Hence, to summarize, a lenticular screen comprising a repetitive pattern of light refracting lenses, or lenticules, is combined with a light-absorbing repetitive pattern to restrict the light passage through the lenticules to only a desired, normally central, portion of the lenticules. A possible way to achieve this light-blocking feature is by applying a black striping, or coating, directly onto the lenticular, by means of screen-printing or inkjet printing. The size and position of the coating can be optimised to get the best compromise between improved crosstalk behaviour and remaining screen brightness. Another possible way is to use an electrically switchable pattern, comparable to the switchable parallax barrier for 2-view 3D monitors. This possibility to switch position or absorption of the light-absorbing feature is important if the lenticular itself is switchable.

Although the invention has generally been described for use in the art of autostereoscopy, it is also envisioned having the invention realized in connection with volumetric displays or other display systems. Furthermore, although the invention has been described using backlight illumination for image production, alternatives may be used as known to a man skilled in the art.

The person skilled in the art realizes that the present invention by no means is limited to the preferred embodiments described above. On the contrary, many modifications and variations are possible within the scope of the appended claims.

1. An autostereoscopic display apparatus comprising lenticular means configured to direct light emitted from a source, said lenticular means comprising lenticular elements, said lenticular elements comprising a first surface facing light incident from said source and a second surface facing light emergent from said second surface, said apparatus further comprising a light-absorbing repetitive pattern restricting light passing through said lenticular elements to a portion of said lenticular elements, said light-absorbing repetitive pattern being applied on said second surface.

2. The autostereoscopic display apparatus as claimed in claim 1, wherein said portion of said lenticular elements comprises a central portion, of a lenticular element.

3. The autostereoscopic display apparatus as claimed in claim 1, wherein said light-absorbing repetitive pattern comprises a black striping applied onto said lenticular elements.

4. The autostereoscopic display apparatus as claimed in claim 3, wherein said black striping is applied in grooves between said lenticular elements.

5. The autostereoscopic display apparatus as claimed in claim 1, wherein said light-absorbing repetitive pattern is applied by at least one of screen-printing and inkjet printing.

6. The autostereoscopic display apparatus as claimed in claim 1, wherein said light-absorbing repetitive pattern comprises an electrically switchable pattern.

7. The autostereoscopic display apparatus as claimed in claim 1, wherein said light-absorbing repetitive pattern provides spacing between said lenticular elements and a glass plate in front of said second surface.

8. (canceled)
